(19) United States
(12) Patent Application Publication
(10) Pub. No.: US 2006/0221834 A1
(43) Pub. Date: Oct. 5, 2006

(54) Method and network node for determining multi-path transmission paths in a packet- switched communication network

(76) Inventors: Gero Schollmeier, Gauting (DE); Christian Winkler, Munich (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/546,947

(22) PCT Filed: Mar. 31, 2003
(86) PCT No.: PCT/DE03/01049

§ 371 Date: Aug. 25, 2005

(30) Foreign Application Priority Data
Feb. 27, 2003 (DE) 102-08-615.3

(51) Int. Cl. H04J 3/14; H04J 1/16; H04L 12/28

(52) U.S. Cl. 370/238; 370/252; 370/254

(57) ABSTRACT

The invention relates to method wherein data packets are respectively transmitted between an input network node and a destination network node via various transmission paths which link network nodes in a packet-switching communication network consisting of various network nodes. Multipath transmission paths are determined by initially determining at least two disjunct transmission paths between input and destination nodes. Direct transmission paths are then at least partially established in the direction of the target network nodes between the network nodes contained in the disjunct transmission paths such that at least two paths are respectively created from a network node of a disjunct transmission path in the direction of the target network nodes. Thirdly, other transmission paths leading via other network nodes are at least partially established between the remaining network nodes of the disjunct transmission paths.

### CROSS REFERENCE TO RELATED APPLICATIONS

This application claims priority to the German application No. 10308615.3, filed Feb. 27, 2003 and to the International Application No. PCT/DE2003/001049, filed Mar. 31, 2003 which are incorporated by reference herein in their entirety.

### FIELD OF INVENTION

The invention relates to a method for determining multipath transmission paths in a packet switching communication network.

### BACKGROUND OF INVENTION

Various routing methods are known permitting data packets in a packet switching communication network, such as a packet switching data network, operated for example in accordance with the Internet Protocol, or IP for short, to be transmitted from an input network node to a destination network node. One group of routing methods are multipath routing methods. With multipath routing data packets are transmitted not via one path or transmission path, respectively routing path but via various transmission paths.

### SUMMARY OF INVENTION

For each input to destination network node pair, multipath routing generates a number of transmission paths or routing paths respectively, also referred to as a hammock.

The sum of all the transmission paths from all input network nodes to an output network node is referred to as a hammock set. Accordingly for each output network node there is a hammock set.

The transmission paths or number of transmission paths from an input to a destination network node must be loop-free in order to avoid circulating data packets. That means that the hammocks must be loop free.

As multipath routing works purely on a destination basis i.e. a data packet is forwarded on the basis of its destination ID or destination address, the corresponding hammock set for each output network node must also be loop free.

Multipath routing ensures greater reliability in transmitting data packets. The more paths there are from an input network node to a destination network node, the greater the transmission reliability. If a transmission path is disrupted, a sufficient number of alternative transmission paths is available. That is of course only true if the alternative path does not run via the disrupted network node or path.

Earlier calculations of the number of paths or hammocks from the standpoint of being loop free, which is a requirement for packet switching based on destination IDs or destination addresses, have shown that in many cases disjunction is not achieved.

An object of the present invention is to improve the ability to determine and select multipath transmission paths in packet switched communication networks.

This object is achieved by the claims.

The method is advantageous in that disjunct loop free multipath transmissions are determined.

Advantageous embodiments of the invention are stated in the sub claims.

In one embodiment of the invention the method steps are repeated and applied to intermediate network nodes. This is advantageous in that a tightly woven, disjunct, largely loop free hammock is created.

According to the invention it is proposed that at first at least two disjunct transmission paths between the input and the destination network nodes be determined with the aid of known shortest path or multipath algorithms, for example the Dijkstra algorithm, used with the Open Shortest Path First method, or OSPF for short, the Bellmann-Ford algorithm as well as Disjoined Path Algorithms or other algorithms or graph theoretical methods.

The network nodes contained in these disjunct transmission paths are then partially, ideally as completely as possible, directly connected with each other in the direction of the target network nodes or else corresponding transmission paths established so that, at least two paths are respectively created in the direction of the target network nodes in respect of one network node of a disjunct transmission path. The direction of the transmission path or connection in the direction of the target network nodes is required in order to avoid routing loops. This may require special treatment of many high-usage routes for example using the “joker link” method according to a previous patent application.

In a third step, further transmission paths leading via other network nodes in the direction of the target network nodes are setup between the remaining network nodes of the disjunct transmission paths i.e. for network nodes which do not yet have a second path in the direction of the target network nodes. In other words, the network nodes of the disjunct transmission paths are connected to network nodes of a different or the same disjunct path via transmission paths leading via one or several other network nodes.

The absence of loops is similarly also to be considered.

If further network nodes emerge during the course of the third step which have only one path in the direction of the target network nodes, the said further network nodes can be transferred to network nodes with at least two transmission paths in the direction of the target network nodes in accordance with the second and/or third step and their continuous repetition.

Alternatively, following application of the second and third steps, the network topology can be extended such that, as far as possible, additional transmission paths can be established in the direction of the target network nodes for the remaining network nodes which, for example, have only one transmission path in the direction of the target network nodes.

If destination based routing is performed having regard to the source identifier or source address of the data packets or to the data packet reception connecting path, the special treatment referred to for routing loops is not required. The absence of loops can be achieved by allowing for the source identifier or the data packet reception connecting path. This involves a network node sending a data packet to a target network node only via a specific connection path if this connection path is also authorized for one or more source identifiers or the data packet was received by network nodes on one or more specific connection paths. That means that data packets intended for the same target network node are forwarded via different connecting paths as a function of their source address or the network node's reception connecting path.

The method can be used selectively in such a way that at most two, three, four or more disjunct transmission paths are determined between input and target network nodes so that two, three, four or more paths are respectively created in the direction of the target network nodes. This can occur in the same manner for the third step.

### BRIEF DESCRIPTION OF THE DRAWINGS

An exemplary embodiment of the invention is shown in the drawing and is described below, in which;

FIG. 1 shows a schematic representation of a communication network to explain the method according to the invention in a first method step.

FIG. 2 shows an arrangement according to FIG. 1 in a second method step.

FIG. 3 shows an arrangement according to FIG. 2 in a third method step.

### DETAILED DESCRIPTION OF INVENTION

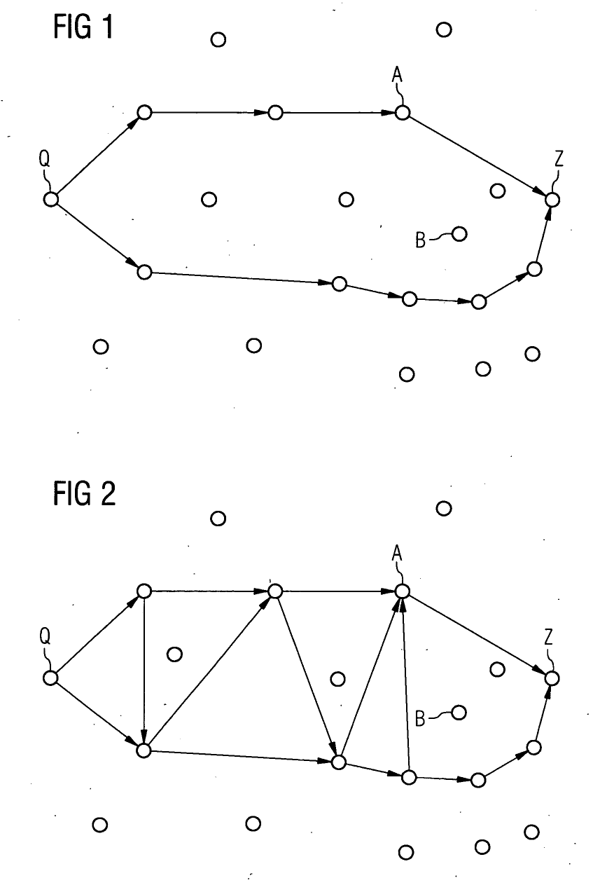

FIG. 1 shows a schematic diagram of a communications network comprising several network nodes which are shown as circles and at least partially interconnected by means of connection paths, or links, not shown.

In the first method step, two or more disjunct or independent transmission paths are determined between an input network node Q and an output network node Z. These paths are represented by arrows between the network nodes, originating from the input network node Q in the direction of the target network node Z.

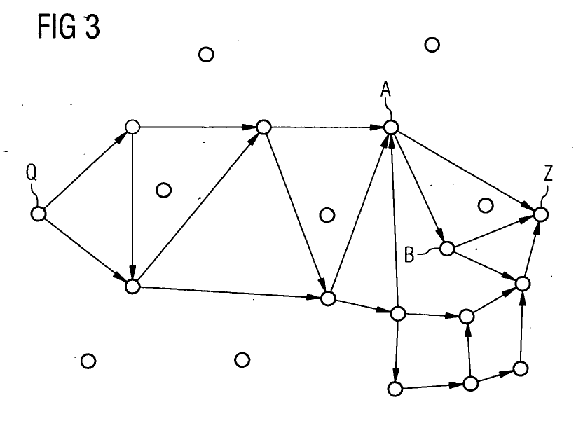

In the second method step, further direct transmission paths are setup in the direction of the target network node Z between the network nodes of the two disjunct transmission paths, as shown in FIG. 2 by means of arrows between the network nodes of the disjunct transmission paths.

In the third process step, network nodes of the disjunct transmission paths are interconnected by means of transmission paths leading via other network nodes. This is shown for example in FIG. 3 using further arrows between the network nodes. By way of example, a network node A of a disjunct transmission path has a direct transmission path to the target network node Z and a second transmission path via a network path B, that is not contained in the transmission path, to target network node Z.

The method may be employed advantageously for voice transmission in data networks such as for example for Voice over IP, or VoIP for short, or for other voice transmission techniques or protocols. The method allows an increased reliability and/or fail-safety when transmitting voice data and/or voice packets in communication networks or data networks.

The close intermeshing and disjunct transmission paths bring about a high degree of fail-safety for voice transmission in quasi real-time.

1.-8. (canceled)

9. A method of determining multipath transmission paths between an input network node and a target network node in a packet switching communication network comprising a number of network nodes, the communication network provided for transmitting data packets via a plurality of connecting paths linking the network nodes, the method comprising:
determining at least two disjunct transmission paths between the input and target network nodes;
setting up direct transmission paths between network nodes contained in the disjunct transmission paths, the direct transmission paths oriented towards the target network node, such that at least two paths from a network node of a disjunct transmission path to the target network node are provided; and
establishing further transmission paths for such network nodes of the disjunct transmission paths not exhibiting two paths from such network nodes to the target network node, the further transmission paths leading towards the target network node via other network nodes.

10. The method according to claim 9, wherein exactly two disjunct transmission paths are determined between the input and target network nodes, and two paths are formed from a network node of each of the disjunct transmission paths in the direction of the target network node.

11. The method according to claim 9, wherein the steps of:
setting up the direct transmission paths between network nodes contained in the disjunct transmission paths, the direct transmission paths oriented towards the target network node, such that at least two paths from a network node of a disjunct transmission path to the target network node are provided; and
establishing the further transmission paths for such network nodes of the disjunct transmission paths not exhibiting two paths from such network nodes to the target network node, the further transmission paths leading towards the target network node via other network nodes, are repeated.

12. The method according to claim 9, wherein further transmission paths are set up between the network nodes of the disjunct transmission paths not exhibiting two paths from the network nodes to the target network node via other network nodes in the direction of the target network node.

13. The method according to claim 12, wherein for such network nodes still not exhibiting two paths from such network nodes to the target network node second further transmission paths are set up between such network nodes via other network nodes in the direction of the target network node.

14. The method according to claim 13, wherein the steps of:
setting up the direct transmission paths between network nodes contained in the disjunct transmission paths, the direct transmission paths oriented towards the target network node, such that at least two paths from a network node of a disjunct transmission path to the target network node are provided; and
establishing the further transmission paths for such network nodes of the disjunct transmission paths not exhibiting two paths from such network nodes to the target network node, the further transmission paths leading towards the target network node via other network nodes, are repeated.

15. The method according to claim 9, wherein the communication network is operated as a packet switching network in accordance with the Internet Protocol.

16. A network node for a packet switching communication network, the network node configured to:
determine at least two disjunct transmission paths between an input network node and a target network node of the network;
set up direct transmission paths between network nodes contained in the disjunct transmission paths, the direct transmission paths oriented towards the target network node, such that at least two paths from a network node of a disjunct transmission path to the target network node are provided; and
establish further transmission paths for such network nodes of the disjunct transmission paths not exhibiting two paths from such network nodes to the target network node, the further transmission paths leading towards the target network node via other network nodes.
